(19) United States
(12) Patent Application Publication
(10) Pub. No.: US 2012/0026008 A1
(43) Pub. Date: Feb. 2, 2012

(54) Personnel monitoring system

(76) Inventor: Brady W. Coleman, Harrisonburg, LA (US)

(21) Appl. No.: 12/804,748

(22) Filed: Jul. 28, 2010

(51) Int. Cl. G08B 5/22

(52) U.S. Cl. 340/870.15

(57) ABSTRACT

A system for monitoring evacuation of personnel from an offshore platform or ship uses personal identification transmitters worn by the crew and passengers, where each of the transmitters has been assigned unique identification parameters. The personal identification transmitters transit a signal that is picked up by a lifeboat-mounted transducer, which acknowledges presence of the wearer of the personal identification transmitter once the persons enters the lifeboat. The signal from the transducer is transmitted, via satellite to a computing machine, which generates a report acknowledging presence of each person on board the lifeboat and comparing the report to a list of persons who had been listed in the personnel-on-board master report. The remote management control centers allow management to issue commands to abandon ship once all persons have been accounted for.

### BACKGROUND OF THE INVENTION

This invention relates generally to a monitoring system for use in marine operations and more particularly to a system and method for rapidly performing a roll call in the event of evacuating personnel from an offshore structure, such as a drilling rig, a production platform, a floating vessel and the like.

Maritime commerce and offshore industry require systems and methods of monitoring and recording data and activity with respect to personnel on board in real time. These industries heavily depend on logistics for safe, effective and efficient performance. The conventional method of recording personnel on board (POB) and performing a muster drill requires yellow tablets and communications over radio. The POB and drills are performed on “yellow tablets” meaning a person is manually writing down who has entered and exited the vessels. The POB sheets can be lost, requiring the crew member who performed the task to perform a recall by memory to account for crew members who have come ashore and returned to the vessel.

Moreover, a vessel or an offshore platform has hundreds of crewmembers and passengers. The conventional method of performing a drill could take up to or longer than one hour. In an emergency situation this outdated roll call method cannot be safely performed. In case of fire, explosion or possible situation requiring an abandonment of a rig or a vessel the yellow tablet method of personnel accounting is not likely to be successful.

Should the captain issue an order to abandon the vessel or rig, the passengers and then the crew must board the lifeboats. At such time, personnel accounting is important more than ever. The captain, or rig manager are responsible for compiling a full report of POB and the results of the report is submitted to the proper authorities.

Additionally, many facilities require that personnel have a special permit to enter certain areas of the facilities. The security regulations require that a monitoring system track the arrivals and departures of personnel on board including personnel cabins, lifeboat allocation, emergency personnel team membership, emergency evacuations and the like. Reports include but are not limited to emergency teams, current on board lists, arrivals and departures in addition to complete POB lists when changes are made. All personnel on board (POB) lists are usually archived for a number of years.

There exists a need for a modern solution of POB system that could provide multiple management stations and unlimited number of readers (data collectors) for real time situational awareness onboard the vessel and at a centralized remote location.

### SUMMARY OF THE INVENTION

It is, therefore, an object of the invention to provide a system for monitoring location of personnel at an offshore facility.

It is another object of the invention to provide a system of expeditiously performing a roll call of personnel and passengers in case of an emergency.

These and other objects of the invention are achieved through a provision of a personnel evacuation monitoring system, which uses a satellite for transmitting signals between an offshore rig, or floating vessel and offsite control center and personnel management stations. The system uses a personal identification device configured to generate and transmit a unique signal assigned to the personal identification device. The personal identification device is worn by each crewmember, each passenger on the floating vessel, each worker on the offshore rig, etc.

A transducer is positioned in an evacuation transport facility, such as a lifeboat, a helicopter, or vessel. The transducer is configured to receive the signal generated by the personal identification devices and create a signal indicative of the user's position in the evacuation transport facility once the wearer of the personal identification device enters the evacuation transport facility. The transducer transmitting the signal indicative of the user's position in the evacuation transport facility via a satellite to a remote computing device, which processes the received signal, and generates a real-time report acknowledging presence of the user in the evacuation transport facility. The report is transmitted in a matter of seconds to an offsite central control center, from where the report may be distributed to various base stations monitored by supervisory personnel.

The supervisory personnel, having access to the personnel-on-board date can issue instructions to the shipmaster to abandon the ship, rig, or other facility in an emergency situation once the report of all persons being evacuated is generated.

In operation, every crewmember or passenger or board a vessel, or a member of a rig personnel is assigned the personal identification device, which has unique signal parameters. These parameters are entered into a central data computer and a master list of persons on board, or persons in an industrial facility is generated. Throughout the presence in such a facility, the user is required to retain the personal identification device on his or her person. A continuous-operation device may send a continuous signal to the data entry computer, via the satellite 16, informing the management that the user is on the rig or vessel.

In case of an emergency, such as fire, explosion, chemical spill, and the like, the shipmaster may order the personnel to evacuate. In such case, the users enter the evacuation transport facility, which can be a lifeboat, where the transducer is positioned. The transducer then either automatically, or upon activation, acknowledges the signal received from each of the personal identification devices and sends these signals, via satellite to the computing device, which processes the signals and creates a real-time report of the persons who entered the lifeboat. Based on the generated report, the control center can issue an expeditious order for the shipmaster to abandon the ship since all persons on board have been accounted for by the transducer reception. Simultaneously, the control center may transmit orders to adjacent ships or offshore rigs ordering them to assist in evacuation of the rig in distress.

### BRIEF DESCRIPTION OF THE DRAWINGS

Reference will now be made to the drawings, wherein like parts are designated by like numerals, and wherein

FIG. 1 is a schematic diagram of the personnel monitoring system of the present invention.

### DETAIL DESCRIPTION OF THE INVENTION

Turning now to the drawings in more detail, numeral designates the personnel monitoring system of the present invention. The system 10 is designed to ensure that all personnel on board a vessel are accounted for once they enter a lifeboat. The system comprises a personal identification device 12 configured to be worn by each crewmember and passenger on a vessel. The personal identification device 12 can be worn by the user (schematically shown in the drawings and identified by numeral 14) as a wristband, a pendant, a tag, or in any other desired fashion. The personal identification device may be powered by a battery, or solar-powered.

The personal identification device 12 is a transducer that emits a signal associated with the individual wearing it. Each personal identification device 12 is programmed to emit a unique signal associated with the particular device 12. The signal emitted by the device 12 can be it a microwave signal, radio signal, or other type of a signal.

The signal transmitted by the device 12 is received by a transducer 30 located in each lifeboat 18. The transducer 30 is configured to receive and identify the signals emitted by each personal identification device 12. The transducers 30 are in communication with a data entry computer or computing device 22 that can be positioned on board or in a remote location accessible by the management or owners of the rig or vessel via satellite transmission.

The signal transmitted by the personal identification device 12 can be also sent to a satellite 16 and the routed to the data entry computer 22, depending on the particular emergency.

The signal emitted by the personal identification device 12 may be continuous, allowing the management to trace position of the crewmember or passenger on the vessel or rig 20 at any time. Alternatively, the transmittal of the signal emitted by the personal identification device 12 may be initiated by the user upon entering a lifeboat 18.

The management of the rig 20 or a vessel may be located in a remote area, from where the communication with the rig 20 is conducted through radio or satellite transmissions. The management is in a position to monitor personnel located on a plurality of rigs 20 or floating vessels.

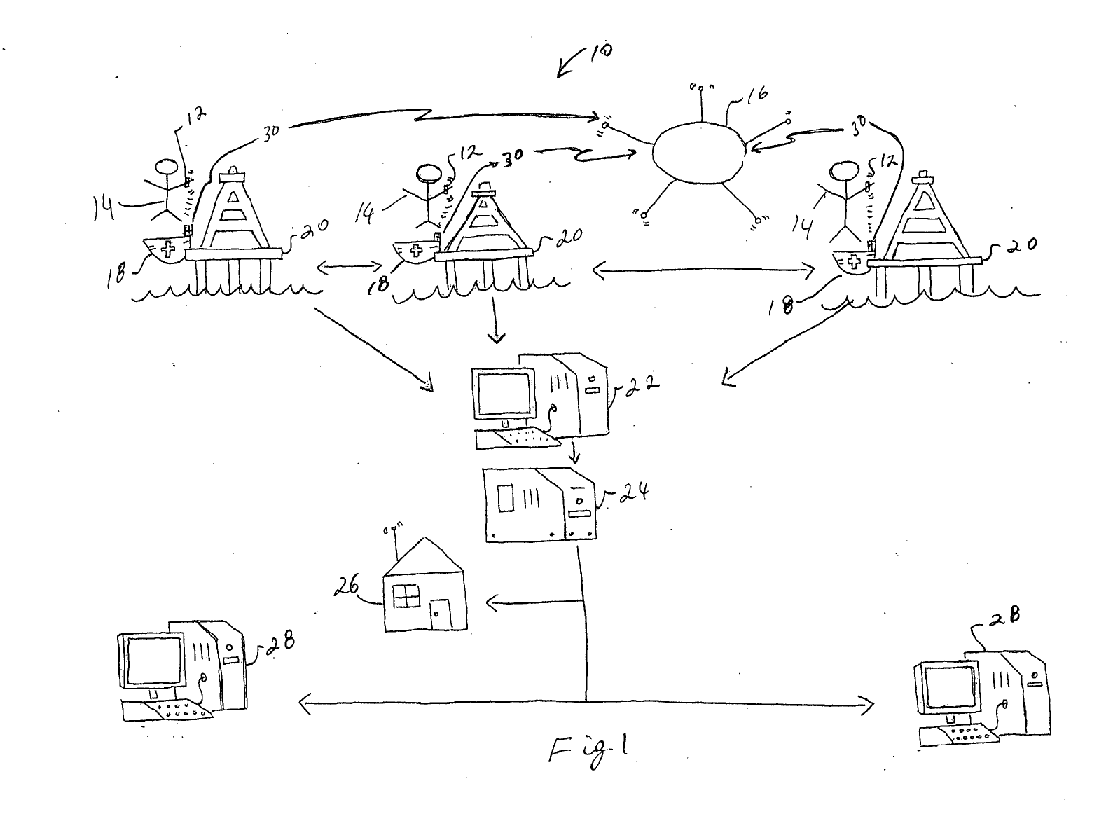

In the illustrative example shown in FIG. 1, the satellite 16 is in a position to communicate with the data entry computer or computer terminal 22. Each of the three rigs 20 shown in the drawing also communicates with adjacent rigs so that personnel of one rig or vessel can come to assistance of the other crew members in case of an emergency, such as an explosion, fire and the like.

The signal transmitted by the personal identification devices 12 of each crewmember or passenger is processed by the data entry computer or computer terminal 22 and forwarded to a remote network control center or server 24. The remote server 24 can be located on land in a central office, which monitors the personnel-on-board system for a plurality of rigs or vessels.

An off-site call center 26 may be provided for inbound and outbound communications with the offsite server 24. The signal processed by the offsite server 24 is forwarded to the call center, from which instructions to on-site personnel can be issued. Additionally, the signal processed by the server 24 can be forwarded to supervisor's computer(s) or control stations 28 located in the remote central office. The management can view real-time reports generated by the computing device 22 and transmitted via satellite 16 indicative of the location of the personnel on their base stations or supervisor's computers 28.

In operation, during an emergency and ordered evacuation, the user 14 activates the personal identification device 12 immediately before entering the lifeboat 18 in cases when the device is user-activated. In a continuous-transmission mode, the user does not need to activate the device 12.

The signal of the personal identification device 12 is received by the transducer 30 and acknowledged as “personnel-on-board” of the lifeboat 18. The signal from the transducer 30 is then transmitted to the data entry computer 22 and, via satellite, to adjacent rigs 20 and the entry data entry computer 22. The data of the particular crewmember or passenger having entered the lifeboat is available almost immediately to the management and the supervisors.

Based on the list of personnel or passengers that were on-board prior to the evacuation, the supervisors can determine who is missing from the roll call in the lifeboats. The supervisors can then send instructions to the master on board the rig or a vessel informing the master on the individuals missing from the lifeboats. In such a case, a search through the vessel may be initiated to locate the missing individuals on an expedited basis.

In operation, every crewmember or passenger or board a vessel, or a member of a rig personnel is assigned a personal identification device 12, and its unique signal parameters are entered into the central data computer 22. Throughout the presence on the rig 20 or presence on a ship, the user is required to retain the personal identification device on his or her person. A continuous-operation device 12 may send a continuous signal to the data entry computer 22, via the satellite 16, informing the management that the user is on the rig or vessel.

In case of an emergency, such as fire, explosion, or mandatory evacuation, the user 14 enters one of the lifeboats, to which the user had been assigned. The transducer 30 located on each lifeboat 18 (or in other safe areas) receives the signal from the continuously transmitting personal identification device 12 and transmits acknowledgement of the received signal to the data entry computer 22. Alternatively, the user 14 may activate the transmitter 12 upon entering the lifeboat 18. Should the user 14 become incapacitated another crewmember may activate the transmitter 12 one the incapacitated crewmember is positioned in the lifeboat 18.

The computer 22 has a previously uploaded list of personnel authorized to be on the rig 20 of a floating vessel. Based on the uploaded personnel list, the computer 22 processes the signals received from the transducer 30 and generates a list of persons on board the rig or vessel, as well as a list of persons who have already entered the assigned lifeboat 18.

The management can access the data processed by the computer 22 on the offsite computer 24, as well as the supervisor's computers 28. The data processed by the data entry computer is also made available to the personnel in the call center 26. Having analyzed the data, the management can direct immediate deployment of the lifeboats 18, abandonment of the rig/vessel, or send instructions to the persons on board as to whether a person who had been assigned to enter the particular lifeboat 18 did not report to the lifeboat, and whose transmitter failed to be acknowledged by the transducer 30.

At the same time, personnel on adjacent rigs 20 may be allowed to access the data entry computer 22 for the purpose of rendering assistance to the personnel on the rig being evacuated.

The system of the present invention allows roll call reports to be almost instantly generated. The list will show who is in attendance on the lifeboat and who is missing. Within seconds the reports can be forwarded to multiple computers or exported to other adjacent rigs or vessels. The system enhances the safety of evacuating personnel from an offshore oil platform or vessel. The system significantly improves traceability of personnel on platform or lifeboat thus ensuring safety of personnel-on-board and compliance with Health, Safety and Environment compliance measures.

The system of the present invention may be also used for accountability and attendance of personnel during emergency situations like hazardous material spill, fire, or man overboard drills. The receivers 30 may be positioned in any restricted area on board a vessel or a rig to allow detection of personnel entering a closed-off area, where a spill has occurred, thus allowing expeditious treatment of an injured person. The system of the present invention, which relies on computer-to-computer communication, reduces unnecessary radio traffic offshore.

It is envisioned that the system of this invention may be used in other emergencies, including but not limited to chemical, nuclear and manufacturing plants, hospitals, schools, and the like. It can be used for mandatory training on board of passenger-carrying vessels. The drill report can be created showing date and time of the drill, attendance, missing persons, and if necessary, how long the drill took to complete. Period reports may be saved in the data entry computer for viewing by management or the appropriate regulatory agencies.

It is envisioned that the transducers 30 may be in the form of proximity sensing devices, recording the presence of the transmitter 12 within a specified distance from the transducer. The transducer may be positioned in a lifeboat or other safety area prescribed by the situational requirements. The emergency evacuation monitoring system provides the ability for management to collect situational report in real time in order to make critical decisions involving the health and safety of the crew and passengers accurately and effectively.

The key benefits of this system are real time, accurate personnel-on-board reports and the ability for the shipmaster and crew to collect information real time. The system is configured to produce accurate real time reports without manually inputting data to confirm the success or failure of the drill or re-location of the crew and passengers into lifeboats, safety transport facility, or to other safety areas.

Many changes and modifications can be made in the system of the present invention without departing from the spirit thereof. I, therefore, pray that my rights to the present invention be limited only by the scope of the appended claims.

I claim:

1. A personnel evacuation monitoring system, which uses a satellite for transmitting signals, the system comprising:
a personal identification device configured to generate and transmit a unique signal assigned to the personal identification device, said personal identification device being configured to be positioned is direct association with an individual user;
a transducer positioned in an evacuation transport facility and configured to receive the signal generated by the personal identification device, said transducer creating a signal indicative of the user's position in the evacuation transport facility, said transducer transmitting the signal indicative of the user's position in the evacuation transport facility via a satellite;
a computing device configured to receive a signal indicative of the user's position in the evacuation transport facility transmitted by the transducer, process the received signal, and generate a real-time report acknowledging presence of the user in the evacuation transport facility.

2. The system of claim 1, further comprising a remote control center configured for communicating with the computing device and at least one remote base station.

3. The system of claim 1, wherein said personal identification device is configured for continuous transmittal of the signal assigned to the personal identification device.

4. The system of claim 1, wherein said personal identification device is configured for activation by the user upon entering the evacuation transport facility.

5. The system of claim 1, wherein said remote control center is capable of communicating with an off-site call center.

6. The system of claim 1, wherein said computing device is capable of receiving and processing signals from a plurality of personal identification devices.

7. The system of claim 1, wherein the personal identification device is battery-powered.

8. The system of claim 1, wherein the personal identification device is solar-powered.

9. The system of claim 1, wherein the transducer positioned in the evacuation transport facility is configured for operational communication with transducers located in adjacent evacuation transport facilities so as to coordinate evacuation of personnel through a plurality of evacuation transport facilities.

10. A method of monitoring personnel evacuation from an offshore facility by an evacuation transport facility, comprising the steps of:
providing a personal identification device and associating the personal identification device with an individual user, said personal identification device being configured to generate and transmit a unique signal assigned to the personal identification device;
providing a transducer and positioning the transducer in the evacuation transport facility, said transducer being configured to receive the signal generated by the personal identification device;
providing a remote computing device configured to receive a signal indicative of the user's position in the evacuation transport facility;
directing the user to enter the evacuation transport facility;
causing the transducer to communicate with the personal identification device, create a signal indicative of the user's presence in the evacuation transport facility, and transmit the signal indicative of the user's presence in the evacuation transport facility via a satellite, to the remote computing device; and
generating with the computing device a real-time report acknowledging the user's presence in the evacuation transport facility.

11. The method of claim 10, comprising a step of providing a remote control center configured for communicating with the computing device and at least one remote base station.

12. The method of claim 11, further comprising a step of transmitting the real-time report generated by the computing device from the remote control center to the at least one remote base station.

13. The method of claim 11, wherein said remote control center is capable of communicating with an off-site call center.

14. The method of claim 10, wherein said computing device is capable of receiving and processing signals from a plurality of personal identification devices.

15. The method of claim 10, wherein said personal identification device is configured for continuous transmittal of the signal assigned to the personal identification device.

16. The method of claim 10, wherein said personal identification device is configured for activation by the user upon entering the evacuation transport facility.

17. The method of claim 10, further comprising a step of causing the transducer positioned in the evacuation transport facility to communicate with transducers located in adjacent evacuation transport facilities, thereby coordinating evacuation of personnel by a plurality of evacuation transport facilities.
